(19) United States
(12) Patent Application Publication
(10) Pub. No.: US 2012/0069462 A1
(43) Pub. Date: Mar. 22, 2012

(54) Outside Mirror for Vehicle

(75) Inventor: Byung Seob YU, Osan-si (KR)

(73) Assignee: HYUNDAI MOTOR COMPANY, Seoul (KR)

(21) Appl. No.: 12/956,190

(22) Filed: Nov. 30, 2010

(30) Foreign Application Priority Data
Sep. 17, 2010 (KR) 10-2010-0091835

(51) Int. Cl. B60R 1/08; G02F 1/1335; B60R 1/06

(52) U.S. Cl. 359/843; 359/850; 349/193; 359/864

(57) ABSTRACT

An outside mirror apparatus mounted to a sidewall of a vehicle to provide a driver's rear view, may include a front glass layer, a transmissivity variation unit attached to a rear surface of the front glass layer, the transmissivity variation unit selectively transmitting light or interrupting light transmission according to an electric signal, a rear glass layer attached to a rear surface of the transmissivity variation unit, and a control unit applying the electric signal to the transmissivity variation unit, wherein the front glass layer and the second glass layer have a different refractive index.

### CROSS-REFERENCE TO RELATED APPLICATIONS

The present application claims priority to Korean Patent Application No. 10-2010-0091835 filed on Sep. 17, 2010, the entire contents of which is incorporated herein for all purposes by this reference.

### BACKGROUND OF THE INVENTION

1. Field of the Invention

The present invention relates generally to outside mirrors for vehicles and, more particularly, to an outside mirror for a vehicle which selectively functions as a plane mirror or a convex mirror depending on the application of an electric signal, thus effectively allowing the driver to view to the rear.

2. Description of Related Art

Generally, vehicles are provided with outside mirrors to ensure the driver's view to the rear. To change the traffic lane, the driver checks the traffic lane he/she wants to move into and whether there is a vehicle behind the driver's vehicle using an outside mirror. Subsequently, the driver turns on a turn signal to let drivers of nearby vehicles know that he/she is going to change the direction in which his/her vehicle is going, and then changes traffic lanes.

As shown in FIG. 5, a typical outside mirror includes a mirror housing 10 which is mounted to a sidewall of a vehicle body, and a mirror 20 which is installed in the mirror housing 10 to reflect the side and behind views of the vehicle.

However, the conventional outside mirror may create a blind spot which cannot be viewed by the driver, so that the driver cannot view a vehicle which is in the blind spot and approaches the side and behind of the driver's vehicle. Thus, when the driver changes traffic lanes, the vehicle which has been in the blind spot abruptly comes into sight. This may cause a vehicle collision. To avoid this, the driver should excessively turn his/her body or face to look back when changing traffic lanes, and while doing so, the vehicle may collide with a pedestrian or a vehicle to the front when the driver momentarily stops looking ahead.

Meanwhile, when the vehicle is moving in reverse, for the driver to view to the rear, the driver may have to adjust the orientation of the outside minor downwards as necessary. In this case, the orientation of the outside mirror has been adjusted manually or with a separate actuator.

However, after the orientation of the outside mirror has been changed, it is difficult to precisely return the outside mirror to its original position. If the separate actuator is used, it is more expensive to manufacture.

To solve these problems, recently, a separate convex mirror was proposed, which is provided on a portion of the outside mirror to prevent a blind spot from being formed and to ensure the driver's view to the rear when the vehicle moves in the reverse direction. However, because the conventional convex mirror is exposed to the exterior of the mirror housing, the convex mirror may be damaged by the external environment or removed from the outside mirror.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an outside mirror for a vehicle which can effectively provide a driver's rear view when the vehicle is traveling or moving in the reverse direction.

In an aspect of the present invention, the outside mirror apparatus mounted to a sidewall of a vehicle to provide a driver's rear view, may include a front glass layer, a transmissivity variation unit attached to a rear surface of the front glass layer, the transmissivity variation unit selectively transmitting light or interrupting light transmission according to an electric signal, a rear glass layer attached to a rear surface of the transmissivity variation unit, and a control unit applying the electric signal to the transmissivity variation unit, wherein the front glass layer and the second glass layer may have a different refractive index.

The transmissivity variation unit may include transparent conductive films, and liquid crystal molecules and a polymer provided between the transparent conductive films, wherein when the electric signal may be applied to the transmissivity variation unit, the liquid crystal molecules may be arranged in a direction of an electric field to allow light to be transmitted through the transmissivity variation unit.

Each of the front and rear glass layers may be attached to the transparent conductive films by an EVA (ethylene vinyl acetate) film.

The front glass layer may include a plane mirror to provide a normal driver's rear view, and the rear glass layer may include a convex mirror to partially expand the normal driver's rear view when the electric signal may be applied to the transmissivity variation unit.

The control unit applies the electric signal to the transmissivity variation unit when the vehicle changes a traffic lane or a gear shift lever may be positioned in a reverse gear.

Each of the front and rear glass layers may be attached to the transmissivity variation unit by an EVA (ethylene vinyl acetate) film.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1A is a view showing an outside mirror for a vehicle, according to an exemplary embodiment of the present invention.

FIG. 1B is a view showing an outside mirror for a vehicle, according to a modification of the exemplary embodiment of the present invention.

FIG. 2 is a sectional view of a transmissivity variation unit of the outside mirror according to an exemplary embodiment of the present invention.

FIG. 3A is a view illustrating the state of the transmissivity variation unit when no electric signal is applied thereto.

FIG. 3B is a view illustrating the state of the outside mirror when no electric signal is applied thereto.

FIG. 4A is a view illustrating the state of the transmissivity variation unit when an electric signal is applied thereto.

FIG. 4B is a view illustrating the state of the outside mirror when an electric signal is applied thereto.

FIG. 5 is a front view showing a conventional outside mirror for a vehicle.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, an embodiment of the present invention will be described in detail with reference to the attached drawings.

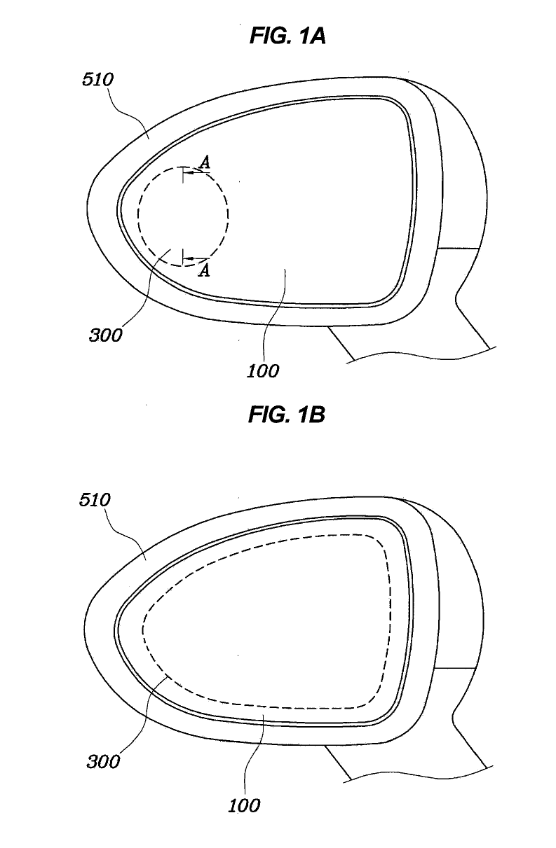

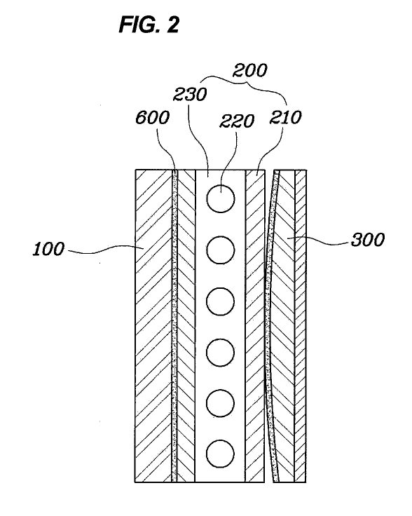

As shown in FIGS. 1A and 2, an outside minor for a vehicle according to an exemplary embodiment of the present invention is configured such that when the vehicle moves forwards or backwards, a driver's view to the rear is effectively ensured by a front glass layer 100 and a rear glass layer 300 which are selectively operated by an electric signal.

The outside mirror includes a minor housing 510, the front glass layer 100, a transmissivity variation unit 200, the rear glass layer 300, EVA films 600 and a control unit 400. The mirror housing 510 is mounted to a sidewall of a vehicle body. The front glass layer 100, the transmissivity variation unit 200, the rear glass layer 300, the EVA films 600 and the control unit 400 are provided in the mirror housing 510. Here, the front of the outside minor means the rear side of the vehicle based on the outside minor. The rear of the outside mirror means the front side of the vehicle based on the outside mirror.

The front glass layer 100 is a glass layer which is disposed in an outermost side of the mirror housing 510, in other words, in the front side of the outside mirror. It is desirable that the front glass layer 100 includes a plane mirror to provide driver's normal rear view under normal conditions. The front glass layer 100 is attached to the transmissivity variation unit 200 by the corresponding EVA film 600.

Each EVA film 600 is made of an ethylene vinyl acetate (EVA) polymer which is superior in terms of transparency, flexibility, adhesibility and weatherability. The EVA film 600 becomes colorless and transparent when heat is applied thereto. Particularly, the EVA film 600 reduces loss of solar light, has superior water-resistance, and is resistant to ultraviolet rays. The EVA film 600 is formed in such a way as that EVA polymer is mixed with a cross-linking agent, a UV absorption agent and an adhesive and then is formed into a film shape by an extruding machine or a rolling machine.

In the exemplary embodiment, the front glass layer 100 and the rear glass layer 300 are attached to the transmissivity variation unit 200 by the corresponding EVA films 600. When heat is applied to the EVA films 600 by an electric signal, the EVA films 600 become transparent so that light is transmitted to the transmissivity variation unit 200 through the front glass layer 100.

The transmissivity variation unit 200 is configured such that when an electric signal is applied thereto, liquid crystal molecules are arranged in the direction of an electric field to allow light to be transmitted through it. It is desirable that the transmissivity variation unit 200 be made of a polymer assembled LCD.

The polymer assembled LCD includes transparent conductive films 210 which are respectively provided at front and rear sides of the transmissivity variation unit 200, and liquid crystal molecules 220 and polymer 230 which are interposed between the transparent conductive films 210 and combined with each other. When no electric signal has been applied to the polymer assembled LCD, the liquid crystal molecules 220 are oriented randomly and thus diffuse light. Thus, the polymer assembled LCD becomes opaque. When an electric signal is applied to the polymer assembled LCD, the liquid crystal molecules 220 which have been oriented randomly arrange themselves in the direction of the electric field and thus allow light to be transmitted.

The rear glass layer 300 is a glass layer which is provided inside the mirror housing 510, that is, at the rear side of the outside mirror. The rear glass layer 300 includes a convex mirror which partially expands the driver's rear view. The rear glass layer 300 is attached to the transmissivity variation unit 200 by the corresponding EVA film 600.

Therefore, when the driver changes traffic lanes or backs up to park, an electric signal is applied to the transmissivity variation unit 200 by the control unit 400. Then, light is transmitted through the front glass layer 100 and the transmissivity variation unit 200 and reflected off of the rear glass layer 300. Thereby, the driver's rear view can be expanded.

In this embodiment, the rear glass layer 300 has an area corresponding to only a portion of the front glass layer 100 and is disposed at a position corresponding to the portion of the front glass layer 100. Alternatively, as shown in FIG. 1B, the rear glass layer 300 may have an area corresponding to the entire area of the front glass layer 100.

The electric signal which is applied to the transmissivity variation unit 200 is controlled by the control unit 400. When the vehicle changes traffic lanes or a gear shift lever is positioned in reverse gear, the control unit 400 applies an electric signal to the transmissivity variation unit 200 so that the driver's rear view can be ensured by the rear glass layer 300.

To achieve the above-mentioned purpose, the vehicle may include a sensor for detecting a change of the traffic lane of the vehicle in conjunction with a direction indicator, and a sensor for detecting whether the gear shift lever is positioned in reverse gear. These sensors detect that the vehicle is changing the traffic lane or moving in the reverse direction and then transmit the detecting signal to the control unit 400. The control unit 400 which receives the detecting signal from the sensors applies an electric signal to the transmissivity variation unit 200.

In this embodiment, although the transmissivity variation unit 200 has been illustrated as being operated, for example, when the vehicle changes traffic lanes or moves in the reverse direction, the transmissivity variation unit 200 may be configured such that an electric signal is applied thereto by a separate operating switch as well as the electric signal generated when the vehicle is changing the traffic lane or moves in the reverse direction.

The operation of the present invention having the above-mentioned construction will be explained below.

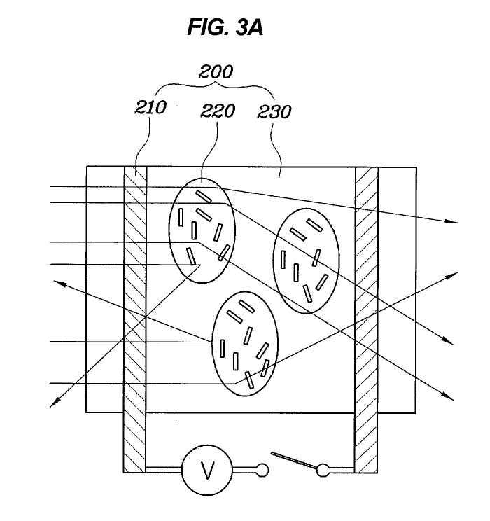

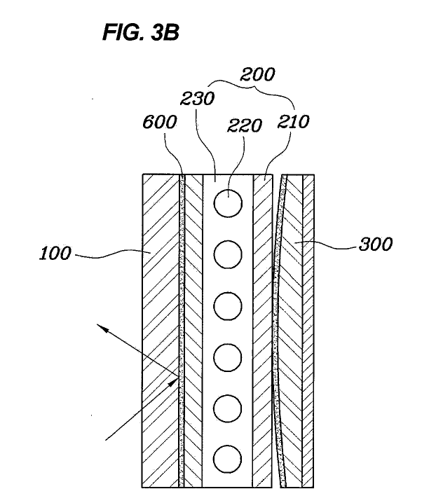

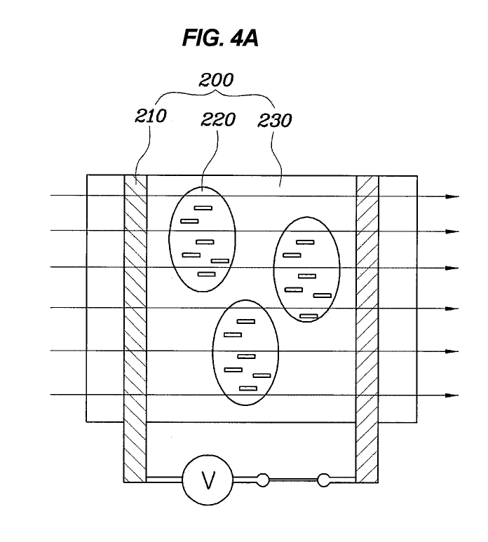

As shown in FIGS. 3A and 3B, under normal conditions, the transmissivity variation unit 200 remains with no electric signal applied thereto. Therefore, the liquid crystal molecules 220 of the transmissivity variation unit 200 are oriented randomly and thus diffuse light. Thereby, the transmissivity variation unit 200 maintains the opaque state.

In this state, when external light enters the front glass layer 100, the light that is transmitted through the front glass layer 100 is reflected off of the front side of the transmissivity variation unit 200. Hence, the driver can view the rear of the vehicle through the plane mirror.

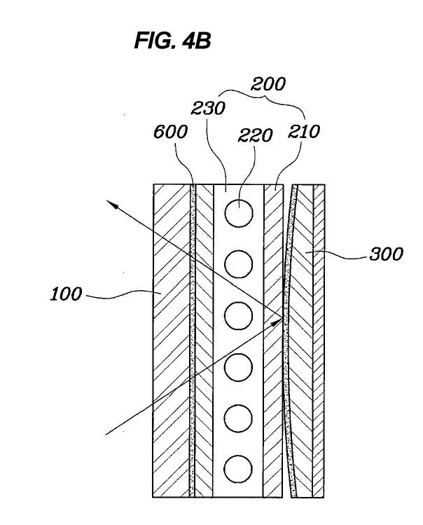

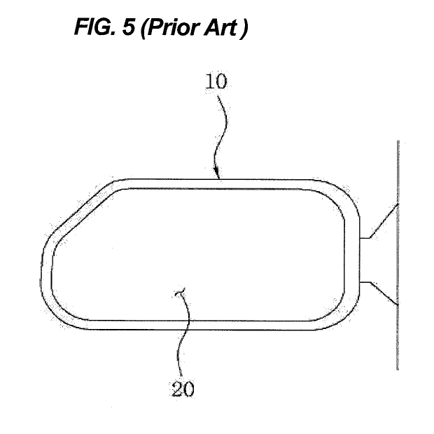

On the other hand, as shown in FIGS. 4A and 4B, when the vehicle changes the traffic lane or the gear shift lever is positioned in reverse gear, the control unit 400 applies an electric signal to the transmissivity variation unit 200. Then, the liquid crystal molecules 220 of the transmissivity variation unit 200 are arranged in the direction of the electric field, thus allowing light to be transmitted through the transmissivity variation unit 200. As a result, the transmissivity variation unit 200 enters the transparent state.

In this state, when external light enters the front glass layer 100, the light that is transmitted through the front glass layer 100 is transmitted through the transmissivity variation unit 200 and then reflected off of the rear glass layer 300. Therefore, the outside mirror can provide partially-expanded rear view to the driver through the convex mirror.

As described above, the present invention has the following effects.

First, a single outside mirror can selectively function as a plane mirror or a convex mirror. Therefore, when the vehicle changes traffic lanes or moves in the reverse direction, the driver's view to the rear can be effectively ensured.

Second, either the plane mirror or the convex mirror can be selected by applying an electric signal. Hence, unlike the conventional technique using the separate actuator, the present invention can fundamentally prevent mechanical malfunction, thus enhancing the reliability of the product For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An outside mirror apparatus mounted to a sidewall of a vehicle to provide a driver's rear view, comprising:
a front glass layer;
a transmissivity variation unit attached to a rear surface of the front glass layer, the transmissivity variation unit selectively transmitting light or interrupting light transmission according to an electric signal;
a rear glass layer attached to a rear surface of the transmissivity variation unit; and
a control unit applying the electric signal to the transmissivity variation unit,
wherein the front glass layer and the second glass layer have a different refractive index.

2. The outside mirror apparatus as set forth in claim 1, wherein the transmissivity variation unit comprises:
transparent conductive films; and
liquid crystal molecules and a polymer provided between the transparent conductive films, wherein when the electric signal is applied to the transmissivity variation unit, the liquid crystal molecules are arranged in a direction of an electric field to allow light to be transmitted through the transmissivity variation unit.

3. The outside mirror apparatus as set forth in claim 2, wherein each of the front and rear glass layers is attached to the transparent conductive films by an EVA (ethylene vinyl acetate) film.

4. The outside mirror apparatus as set forth in claim 1, wherein the front glass layer comprises a plane mirror to provide a normal driver's rear view, and the rear glass layer comprises a convex mirror to partially expand the normal driver's rear view when the electric signal is applied to the transmissivity variation unit.

5. The outside mirror apparatus as set forth in claim 1, wherein the control unit applies the electric signal to the transmissivity variation unit when the vehicle changes a traffic lane or a gear shift lever is positioned in a reverse gear.

6. The outside mirror apparatus as set forth in claim 1, wherein each of the front and rear glass layers is attached to the transmissivity variation unit by an EVA (ethylene vinyl acetate) film.

7. The outside mirror apparatus as set forth in claim 1, wherein the rear glass layer has an area corresponding to a portion of the front glass layer and is disposed at a position corresponding to the portion of the front glass layer.

8. The outside mirror apparatus as set forth in claim 1, wherein the rear glass layer has an area corresponding to the entire area of the front glass layer.
